(19) United States
(12) Patent Application Publication
(10) Pub. No.: US 2007/0239337 A1
(43) Pub. Date: Oct. 11, 2007

(54) System and method of optimizing ground engaging operations in multiple-fields

(75) Inventor: Noel Wayne Anderson, Fargo, ND (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/400,895

(22) Filed: Apr. 10, 2006

(51) Int. Cl. G06F 19/00

(52) U.S. Cl. 701/50

(57) ABSTRACT

A method of optimizing a plurality of ground engaging operations in a plurality of geographic units, with each ground engaging operation carried out using a respective work machine, includes the steps of: for each of the ground engaging operations, establishing an assumed start time and execution time associated with the ground engaging operation, determining a value associated with the ground engaging operation at the start time, quantifying a number of determined costs not associated with the ground engaging operation, identifying a number of manageable costs associated with the ground engaging operation, and determining a net profit associated with the ground engaging operation; determining a total profit associated with all of the ground engaging operations; and providing a schedule to an operator corresponding to all of the ground engaging operations.

### FIELD OF THE INVENTION

The present invention relates to a system and method for scheduling ground engaging activities, and, more particularly, to a system and method for scheduling ground engaging activities dependent upon variable input parameters.

### BACKGROUND OF THE INVENTION

Agricultural businesses have become larger in recent years, primarily for efficiency reasons. A common agricultural business owns, rents and/or share crops multiple fields which can be located in a single geographical region or split between multiple geographical regions. Because of the larger sizes of farming operations, the soil types can vary between fields. Some soil types (such as sandier soils) allow easier access for ground engaging operations, such as tillage, planting, fertilizing, spraying, cultivating and harvesting, while other soil types (such as clay soils) are more difficult to access. Additionally, because the farms are larger and it takes longer to cycle through all of the fields for a particular type of ground engaging operation (e.g., harvesting), it is common to stagger the maturity of crop varieties so that not all fields are at an ideal harvesting stage at the same time.

Typically, the scheduling of a ground engaging operation in multiple fields is done in an informal manner by an operator, primarily dependent upon proximity to the fields. In other words, a farmer moves equipment to a particular geographical region and sequentially performs a ground engaging operation on all relevant fields at that region prior to moving to the next geographical region. This avoids multiple transportation costs of moving equipment back and forth between the same regions, but may not in fact be the optimum scheduling sequence to maximize profit. Further, the equipment is typically operated at a speed in which the ground engaging operation can be carried out at an optimum efficiency and quality; however, always operating equipment at an optimum operating speed again may not maximize total profit for the agricultural business.

What is needed in the art is a scheduling method for timing, sequencing and execution of ground engaging operations to maximize total profit for an agricultural business.

### SUMMARY OF THE INVENTION

The present invention provides a method and system for analyzing real time variable inputs to a number of sequential ground engaging operations in different geographic units (e.g., harvesting operations in fields), and providing a schedule to an operator indicating the sequence and timing of the ground engaging operations.

The invention comprises, in one form thereof, a method of optimizing a plurality of ground engaging operations in a plurality of geographic units. Each ground engaging operation is carried out using a respective work machine The optimizing method includes the steps of: for each of the ground engaging operations, establishing a start time and execution time associated with the ground engaging operation, determining a value associated with the ground engaging operation at the start time, quantifying a number of determined costs not associated with the ground engaging operation, and identifying a number of manageable costs associated with the ground engaging operation; modifying the establishing step, determining step and/or identifying step; and ascertaining optimized operating parameters associated with each of the plurality of ground engaging operations.

The invention comprises, in another form thereof, a method of optimizing a plurality of ground engaging operations in a plurality of geographic units. Each ground engaging operation is carried out using a respective work machine. The optimizing method includes the steps of: for each of the ground engaging operations, establishing an assumed start time and execution time associated with the ground engaging operation, determining a value associated with the ground engaging operation at the start time, quantifying a number of determined costs not associated with the ground engaging operation, identifying a number of manageable costs associated with the ground engaging operation, and determining a net profit associated with the ground engaging operation; determining a total profit associated with all of the ground engaging operations; and providing a schedule to an operator corresponding to all of the ground engaging operations.

The invention comprises, in yet another form thereof, a system for optimizing a plurality of ground engaging operations in a plurality of geographic units. Each ground engaging operation is carried out using a respective work machine. The system includes a non-volatile memory with data corresponding to a value of each ground engaging operation at an assumed start time, and at least one manageable cost associated with each ground engaging operation. An electrical processing circuit coupled with the memory is configured for determining an optimized total profit associated with all of the ground engaging operations using a summation of net profits respectively associated with each ground engaging operation, a value associated with each ground engaging operation, and a number of manageable costs associated with each ground engaging operation. The net profits are dependent upon an assumed start time and execution time associated with the respective ground engaging operations. An operator output device provides a schedule to an operator corresponding to the optimized total profit.

### BRIEF DESCRIPTION OF THE DRAWINGS

FIG. 1 is a schematic representation of an agricultural business operation with multiple fields worked with a work machine;

FIG. 2 is a schematic representation of an embodiment of a system used to carry out the method of the present invention; and

FIG. 3 is a flow chart of the high level logic of an embodiment of the method of the present invention.

### DETAILED DESCRIPTION OF THE INVENTION

Referring now to the drawings, an embodiment of the method and system of the present invention for optimizing ground engaging activities will be described in greater detail. In the embodiment shown and described below, the method and system are assumed to be carried out in multiple fields using a harvester, but the invention can be employed in other applications with different geographic units worked by different types of work machines. For example, the geographic units may be fields and the work machine can be a vehicle for scouting or a tractor pulling a tillage implement, planter, sprayer or fertilizer spreader. Alternatively, the geographic unit can be a woodlot and the work machine can be a logging machine. Further, the geographic unit can be a construction site and the work machine can be a bulldozer, excavator, backhoe, etc.

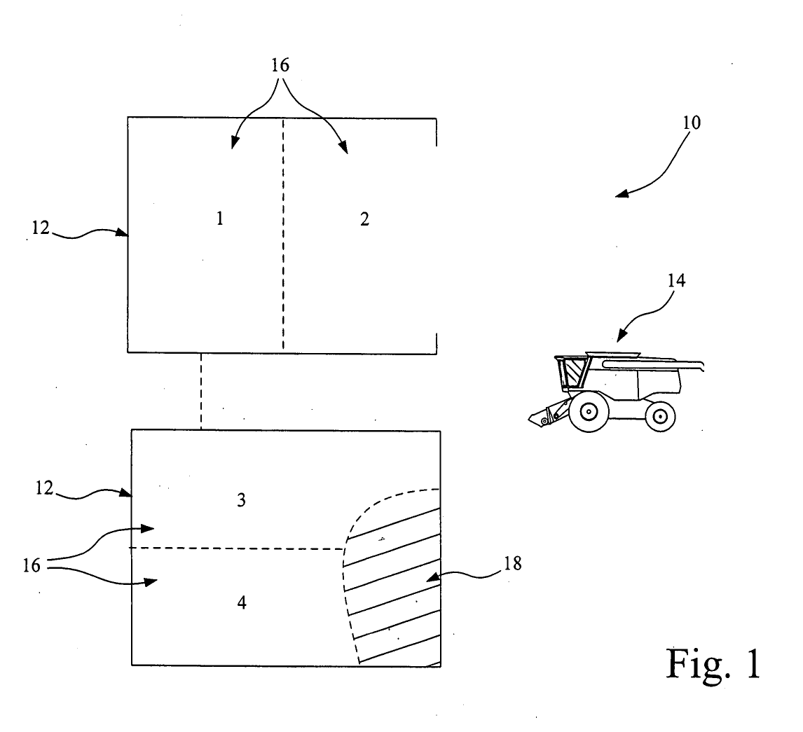

Referring to FIG. 1, there is shown a schematic representation of an agricultural business operation 10 with field operations taking place in on or more geographic regions 12 worked with a work machine 14. Work machine 14 can be a combine (as shown), tractor, etc. Each geographic region 12 includes one or more geographic units represented by fields 16. Each field 16 has a particular size and shape, and can be adjacent another field 16 or non-field area such as a woodlot 18. It is desired to carry out a ground engaging activity such as harvesting in each of the fields 16; however, it is also desired to schedule the harvesting operations with a timing, sequencing and execution to maximize the total profit for the agricultural business operation 10.

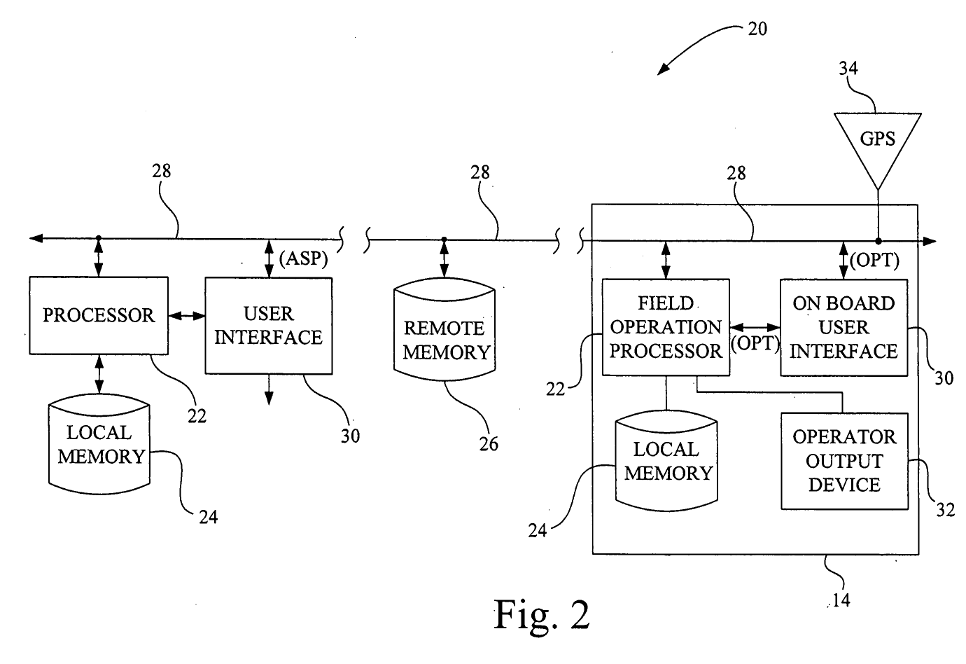

Referring now to FIG. 2, there is shown a schematic representation of an embodiment of a system 20 for carrying out the method of the present invention. There are a number of system architectures that could support the method; however, two will be described below: on-farm and Application Service Provider (ASP). Other combinations and variations are of course possible. In both cases, the method may be employed continuously or periodically to provide the best field schedule based on the most recent weather, crop, and field condition information. An operator may want to look at a number of schedules to see their sensitivity to weather and other factors. The operator may also modify component parameters to explore the benefits of adding labor and equipment for particular fields, changing workday rules, etc. If the system is continuously generating and evaluating schedules, it could notify an operator when a significant change occurs.

In both the on-farm and ASP versions, a processor 22 performs the scheduling and option analysis methods and managing the collection of information from a variety of sources including data bases stored in a local memory 24 and/or remote memory 26 via a network 28. Network 28 may be a hardwired and/or wireless network, depending upon the application. In the on-farm version, a user interface 30 is located onboard work machine 14 in communication with the processor 22. In the ASP version, user interface 30 at the remote location communicates with processor 22 onboard work machine 14 over network 28. Both the on-farm and ASP versions may send an alerting signal to an operator output device 32 when significant schedule changes occur. Operator output device 32 may provide a visual output such as a video display and/or email notification, or an audio output such as a page, phone call, beep and/or alarm.

The optimum average speed for the current field, which in turn determines field operation time, may also be sent to a field operation speed processor 22. Processor 22 can control the instantaneous field operation speed using known closed-loop control methods. The target average speed may be modified in light of current field equipment capacity, current field operation quality, current field conditions, and other real-time or mapped data to determine the best current target speed for the closed-loop speed control system. If mapped data is used, a geopositioning sensor such as GPS 34 may be employed on work machine 14.

The operator may have the option to override the calculated target speed with on-board user interface 30. The user interface 30 may have audio input and output as well as visual output display of the current targeted speed. User interface 30 may also output the field operation schedule value at the current, higher, and lower speeds and for different risk or probability levels.

The ground engaging operation (e.g., harvesting) is modeled with the method of the present invention as a task with the following high level attributes:

1. Start time and execution time

2. A crop value before the operation

3. Determined cost

4. Manageable cost

For a given field i, an operation starting at time tₛₜₐᵣₜ will generate a profit, pᵢ, equal to the value of the crop before the operation, vᵢ, less the determined costs for the field, c_{di}, and less the manageable costs for the field, cₘᵢ. In equation form this becomes
pᵢ=vᵢ−c_{di}−cₘᵢ|Tₛₜₐᵣₜ
For a farm with N fields, the total farm profit, Pₜₒₜ, is
pₜₒₜ=Σ₁^{N}pᵢ
The present invention attempts to maximize total farm profit, pₜₒₜ, by finding the best schedule for performing the operation in the field set. The high level task attributes identified above are further defined and described below.

### 1. Start Time And Execution Time

The start time, tₛₜₐᵣₜ, is simply the time at which a field operation begins and is readily selected by the operator. The end time, t_{end}, is simply the start time plus the execution time. The execution time for a field, tₑₓ, is another manageable parameter and is calculated as
tₑₓ(hrs)=f_{size}(acres)*fᵣₐₜₑ⁻¹(acres/hour)*f_{eff}⁻¹
The field size, f_{size}, is fixed. The field rate, fᵣₐₜₑ is equal to the average speed of the equipment through the field times the width of the equipment. The width is typically fixed, but the speed is variable and a key parameter of interest in this method. The field efficiency, f_{eff}, is the portion of the time activity is taking place at fᵣₐₜₑ. This parameter can be varied by changing equipment and labor and varies across fields on a given farm.

The method assumes the time duration a machine will spend in the field. Machine capacity, crop density (for harvesting) and trafficability can be major effects on the time in the field. These variable can be recognized in some form within the method of the present invention.

### 2. Crop Value Before the Operation

The crop value is the yield times the expected or minimum selling price from a producer's marketing plan. The yield estimate can be selected from a number of sources of varying quality. Historical county average data is available over the internet. A better estimate is the historical field average. Ground-truthed remotely sensed maps can give a high resolution and adequately accurate estimate of crop yield.

Crop yield at a selected field 16 may also be predicted with a dynamic model, such as the Precision Agricultural-Landscape Modeling System (PALMS) computer program. This program predicts crop conditions, soil conditions and crop yield, based upon predicted weather conditions, measured soil conditions, and crop season parameters. The program is available under license for research or commercial use through the Wisconsin Alumni Research Foundation. Information on the PALMS program is currently available at the website http://www.soils.wisc.edu/˜norman/RESAC/agric/palms.html

Another variable affecting the value of the ground engaging operation can be the marketing method employed for selling the crop, since a major factor on farm profitability is commodity price.

### 3. Determined Cost

Rather than using the standard categories fixed cost and variable cost, the method of the present invention uses the phrases determined cost and manageable cost. Determined costs are costs that are not impacted by the current field operation. At harvest, all the seeding, fertilizing, and spraying costs have been set and nothing will change them. Only the costs associated with removing crop from the field can be managed. At planting, fertilizing, spraying, and harvesting costs would be determined. Since they are not known at planting, they need to be estimated from farm or published data.

### 4. Manageable Cost

Manageable costs are costs that can be varied as part of the current field operation such as equipment, labor, and loss & damage. Equipment costs may be calculated on a per acre, per hour, or per bushel basis. Labor is almost always a per hour expense.

Loss and damage, in this model, has four sources: equipment, weather, crop, and latent. There may be some debate as to whether, say, a harvest loss from ears falling to the ground as the header impacts them is due to poor header settings, a growing season that promoted stalk rot, crop genetics for weak stalks, or last year's decision to plant no-Bt corn-on-corn even though European corn borer had been observed in the field. Regardless of the classification, the loss should be noted and accounted for somewhere in the method.

First is loss and damage from the equipment performing poorly in the field. At planting, it would include non-emerged plants from planter skips, cracked seeds, and poor seed depth. At harvest, it would include shelled grain left on the ground and grain damaged by the combine.

Second is the expected loss from weather events such as rain, hail, and snow. At planting, crops need to be in the ground by a certain date to get adequate heat and sun or avoid excess heat and drought. At harvest, crop needs to be removed before heavy seasonal rain, snow, and storms (e.g., monsoons and hurricanes) arrive.

Third is crop loss from operation timing. It may be weather related and can be debated whether it is a genetic or environmental casualty. At planting, it would include the classic planting data curves that show yield losses both before and after the optimal planting date. At harvest, a similar curve shows loss from early harvest due to increased drying costs and loss from late harvest due to ear losses and reduced grain mass.

Finally, latent costs are costs that will not be recognized in the current operation, but will impact the future value of crops. They are charged to the current operation so they can correctly impact scheduling decisions. Examples include soil compaction, poorly distributed trash on fields, and promotion of disease and pests.

The transport of equipment between geographic regions 12 and fields 16 is a manageable cost that should be considered in this scheduler. This can be a significant cost for some operators. The method of the present invention would provide a farm system optimal recommendation where transport costs can be minimized and yield maximized. The transport time (assuming total transport between fields is approximately 500 miles) can range from 20% of the field operation for harvesting to 90% for a faster operation such as spraying. While these numbers can change for a particular farming operation, transport can consume significant time and resources and should be considered in the method of the present invention.

Fuel costs are another manageable cost that can be considered in this method. This may be related to transportation costs. If a 2500 acre farmer has several fields, with a total transport distance of 500 miles, then annual fuel can costs can be between $1,000-$1,500 depending on the price of the fuel.

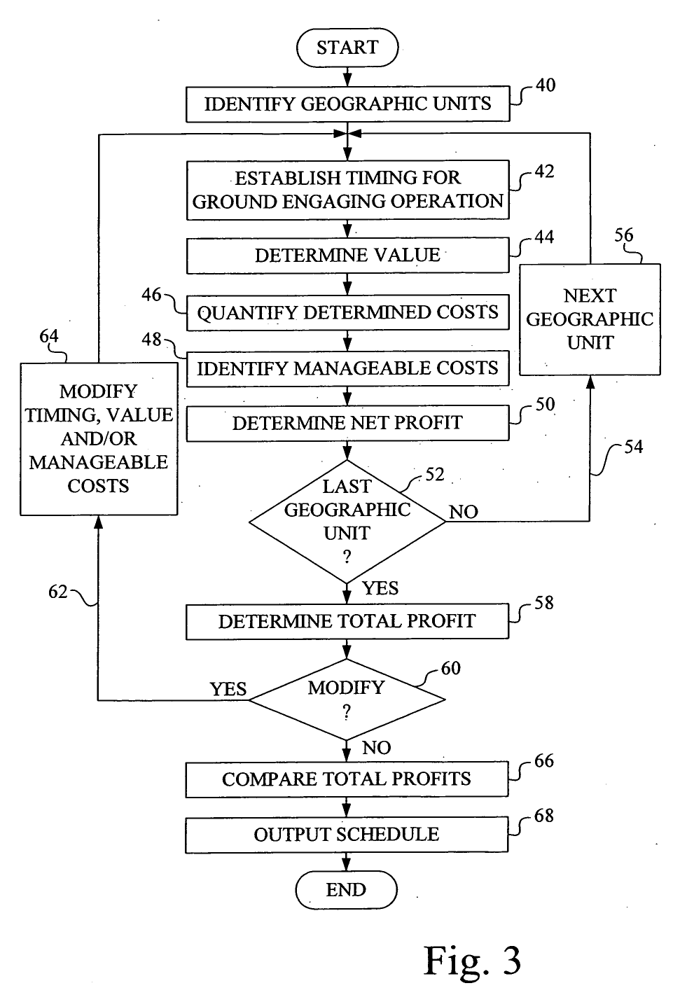

Using the high level attributes described above, the method may be carried out manually or implemented as one or more computer programs or a combination thereof. Referring to the high level logic shown in the flowchart of FIG. 3, the geographic units (fields) 16 over which the ground engaging operation is to be performed are identified (step 40). For each geographic unit, the method determines a timing, value, determined costs and manageable costs associated with the ground engaging operation (steps 42, 44, 46 and 48). For the assumed values of the timing, value, determined costs and manageable costs, a net profit for the ground engaging operation in that geographic unit is determined (step 50). A net profit for each geographic unit is determined in a similar manner (decision step 52, return line 54 and step 56). After the net profits for each geographic unit have been calculated using assumed values for the timing, value, determined costs and manageable costs, a total profit is determined (step 58). It may be desirable to modify certain of the input parameters, namely the timing, value and/or manageable costs to determine the affect on the total profit (decision step 60, return line 62 and step 64). Thus, a number of total profit scenarios can be computed and compared with each other to determine an optimum schedule for timing, sequence and execution of the ground engaging operation which is provided to an operator (steps 66 and 68).

The particular order and configuration of the method steps can have some change made to it without loss of functionality. For example, the method may include the steps:
1. Define a calendar window for the field operation
2. Set workday rules
3. Make time unavailable due to weather and due to personal commitments
4. Calculate optimum operation date for each field and amount of time needed to perform operation
5. Map each field into available time slots
6. For the first field in the schedule, use of real option analysis to determine the value-to-cost and volatility of speeding up the operation in that field to create an option to do later field work earlier.

A unique feature of the method of the present invention is the ability of a producer to “buy an option” on incremental profits from later fields by increasing the speed (reducing the execution time) for the current field and pulling later fields forward in time. This changes the operation speed choice from tradition, “gut feeling”, or “rules of thumb” to one that can be made with business justification for risk and return.

### 1. Define A Calendar Window For the Field Operation

The start and end dates for the window may be related to statistical dates such as first and last frosts, expected date of crop maturity, or personal needs and preferences. The running example started below shows a window of 14 days starting September 21st. Each day is broken into 6 blocks, 4 hours in size.

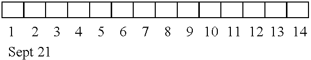

### 2. Set Workday Rules

The number of hours available each day for the operation are set as well as rules for when fewer and greater number of hours can be worked. For example
Workday=12 hours
One 24 hour day/week if extra effort provides >$X of incremental profit
Start new field only if 2 hours is available after interfield travel
Work up to 2 hours later to finish a field.

The 12 soft unavailable hours each day are shown with ‘u’s below

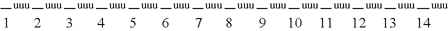

### 3. Make Time Unavailable Due To Weather And Due To Personal Commitments

Using forecasts as well as historic weather data, time is allocated for weather delays. Before the start of the window is reached, the historic weather delay time should be lumped together for each week—probably at the start or end. It can be moved, but not decreased within a week until a forecast indicates that the weather allocation is not needed. Based on forecasts, the weather allocation may also be increased. The 2 unavailable weather days each week are shown with ‘X’s below, lumped at the end of the week.

At this step, time can also be allocated for non-movable down times such as medical, business, and family commitments. Day 10 is shown unavailable with ‘P’s below. 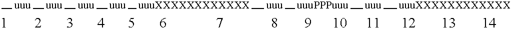
When the scheduling algorithm is run during the window, the weather X's are moved and/or eliminated according to short term forecasts and actual weather. The role of lumped X's when the algorithm is run pre-window is to reserve amounts of time when field work historically cannot be done.

Values for predicted weather conditions at a selected field 16 can be obtained from sources such as the National Weather Service website, operated by the National Oceanic and Atmospheric Administration. Values for crop conditions and soil conditions at a selected field 16 may be predicted with a dynamic model, such as the Precision Agricultural-Landscape Modeling System (PALMS) computer program. This program predicts crop conditions, soil conditions and crop yield, based upon predicted weather conditions, measured soil conditions, and crop season parameters.

### 4. Calculated Optimum Operation Date For Each Field And Amount of Time Needed To Perform Operation

This will be done using the best information available as indicated in the previous section. Assume there are 9 fields to be harvested taking a total of 88 hours of the 120 hours available as with start dates and harvest times indicated in the table of step 5.

### 5. Map Each Field To Available Time Slots

The mapping of the fields is shown with field ID numbers in the schedule. Fields that were scheduled using workday rules from step 1 are explained in the comments section of the table (only 4 fields are shown in FIG. 1 for simplicity sake, while 9 fields are illustrated below for purposes of explanation).

| | Optimum | Estimated | |
|---|---|---|---|
| | Start | Hours | |
| Field ID | Date | To Harvest | Comments on Scheduling |
| 1 | 5 | 8 | Move to day 4 to resolve |
| | | | scheduling conflict with field 3. |
| 2 | 11 | 12 | |
| 3 | 5 | 12 | |
| 4 | 1 | 14 | Scheduled all on one day since |
| | | | workday can be extended by 2 |
| | | | hours to finish field |
| 5 | 8 | 8 | |
| 6 | 2 | 6 | |
| 7 | 9 | 8 | |
| 8 | 2 | 8 | Split field between days 2 and 3 |
| 9 | 13 | 12 | Move weather allocation days to |
| | | | accommodate this field at this |
| | | | time. |

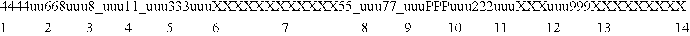

### 6. For the First Field In the Schedule, Use Real Options Analysis To Determine the Value-To-Cost And Volatility of Speeding Up the Operation In That Field To Create An Option To Do Later Fields Earlier

Essentially, the software used in this phase explores opportunities to increase profit overall by decreasing profit when performing an operation in a given field. Some examples of a profit sacrifice might be reduced stand from higher planting speed or increased grain loss from higher combine speed. Increases in overall profit might come from yield increases from crop being planted or harvested within an optimum window.

Using a harvest example, one or more fields can be at profit risk due to local weather or because too many fields need to be optimally harvested at the same time. Profit from these fields may be saved (S) by pulling their harvest forward in time, but the cost is reduced profit from an earlier field (X) that will experience higher grain losses due to a higher harvest speed. By examining the schedule, the decision to speed up harvest in a field may be deferred some number of days (t). By feeding the current schedule into a harvest workday model (with optional crop drydown model) along with 100 year historical weather data, the variance in profit outcome from the schedule change is analyzed. As the time moves forward, the values of both t and σ decrease until t reaches the point where the decision actually must be made based on the expected value of the change relative to its cost.

In general, the number of variable (manageable) input parameters to the scheduling of the ground engaging operations can be analyzed as appropriate to determine an optimum schedule for the sequence, timing and execution of the ground engaging operations. Certain of the manageable costs can be held constant while others can be varied to determine the affect on the total profit of the farming business. In certain instances it may be desirable to isolate and modify a single manageable cost to determine the affect on the total profits, while in other instances it may be desirable to isolate and modify multiple manageable costs to determine the affect on the total profit. The determination of which manageable costs should be varied and the extent to which they should be varied in determining an optimum schedule can be determined automatically using an appropriate software algorithm, such as a genetic algorithm, or can be determined manually through user interaction via user interface 30.

The following describes further refinements and extensions to the method of the present invention described above.
Sub-field management zones. The above discussion is limited to whole fields as management units - primarily for simplicity of discussion. The scheduling algorithm, fed by data indicating site-specific field or crop readiness, could split up fields for scheduling. For example, 60 acres ready for harvest could be harvested now and the remaining 20 acres could be harvested in two days when they have dried out. The scheduling algorithm would need to consider the costs associated with visiting a field twice.
Analysis of equipment and personnel decisions. The above discussion focuses on managing the start of field operations and their duration based on field speed. The method can be extended to include changes in field efficiency due to extra equipment and people.
Extension to timber. In some locations, winter snows, heavy rains, and hurricanes can impact not only the timing of timber harvest, but the value of the tree harvesting. The method of the present invention can be adapted to this and other off-road applications such as construction.

Having described the preferred embodiment, it will become apparent that various modifications can be made without departing from the scope of the invention as defined in the accompanying claims.

1. A method of optimizing a plurality of ground engaging operations in a plurality of geographic units, each said ground engaging operation carried out using a respective work machine, said optimizing method comprising the steps of:
for each of said ground engaging operations, said optimizing method including the substeps of:
establishing a start time and execution time associated with said ground engaging operation;
determining a value associated with said ground engaging operation at said start time;
quantifying a number of determined costs not associated with said ground engaging operation; and
identifying a number of manageable costs associated with said ground engaging operation;
modifying at least one of said establishing step, said determining step and said identifying step; and
ascertaining optimized operating parameters associated with each of said plurality of ground engaging operations.

2. The method of optimizing a plurality of ground engaging operations of claim 1, wherein after said modifying step, said method includes the step of maximizing total profit for all of said ground engaging activities.

3. The method of optimizing a plurality of ground engaging operations of claim 1, wherein said optimized operating parameters include at least one of a sequence of said plurality of ground engaging operations, a timing of said plurality of ground engaging operations, and at least one execution parameter for a respective work machine associated with each said ground engaging operation.

4. The method of optimizing a plurality of ground engaging operations of claim 3, wherein said timing of said plurality of ground engaging operations includes said start time and said execution time for each of said plurality of ground engaging operations.

5. The method of optimizing a plurality of ground engaging operations of claim 3, wherein said at least one execution parameter includes an operating speed of said respective work vehicle.

6. The method of optimizing a plurality of ground engaging operations of claim 1, wherein said ground engaging operation comprises an agricultural operation, and said value comprises a crop value.

7. The method of optimizing a plurality of ground engaging operations of claim 6, wherein said crop value is based upon an expected yield and a target selling price.

8. The method of optimizing a plurality of ground engaging operations of claim 7, wherein said expected yield is based upon at least one of historical field data, historical county average data, and position based remote field sensing.

9. The method of optimizing a plurality of ground engaging operations of claim 1, wherein said ground engaging operations comprise agricultural operations, and said manageable costs include at least one of equipment costs, labor costs, and crop loss and damage costs.

10. The method of optimizing a plurality of ground engaging operations of claim 9, wherein said crop loss and damage costs include at least one of:
crop loss and damage caused by equipment;
crop loss and damage caused by weather;
crop loss and damage caused by timing of said ground engaging operation; and
crop loss and damage caused by latent conditions.

11. The method of optimizing a plurality of ground engaging operations of claim 10, wherein said latent conditions include at least one of soil compaction, poorly distributed trash on field, and promotion of disease and pests resulting from said ground engaging operation.

12. The method of optimizing a plurality of ground engaging operations of claim 1, wherein said ground engaging operation comprises one of an agricultural operation, timber operation and construction operation.

13. The method of optimizing a plurality of ground engaging operations of claim 1, wherein each said ground engaging operation comprises an agricultural operation in the form of one of a harvesting operation, planting operation, spraying operation, tilling operation, cultivating operation and fertilizing operation.

14. The method of optimizing a plurality of ground engaging operations of claim 1, wherein each of said plurality of geographic units comprises at least a portion of a field.

15. The method of optimizing a plurality of ground engaging operations of claim 14, wherein each of said plurality of geographic units comprises one of a plurality of fields.

16. A method of optimizing a plurality of ground engaging operations in a plurality of geographic units, each said ground engaging operation carried out using a respective work machine, said optimizing method comprising the steps of:
for each of said ground engaging operations, said optimizing method including the substeps of:
establishing an assumed start time and execution time associated with said ground engaging operation;
determining a value associated with said ground engaging operation at said start time;
quantifying a number of determined costs not associated with said ground engaging operation;
identifying a number of manageable costs associated with said ground engaging operation; and
determining a net profit associated with said ground engaging operation;
determining a total profit associated with all of ground engaging operations; and
providing a schedule to an operator corresponding to all of said ground engaging operations.

17. The method of optimizing a plurality of ground engaging operations of claim 16, including the steps of:
repeating said substeps for each said ground engaging operation with different values for at least one of said start time, said execution time, said value associated with said ground engaging operation, and said manageable costs;
determining a second total profit associated with all of said ground engaging operations; and
determining an optimized total profit by comparing said total profit with said second total profit;
wherein said schedule provided to an operator corresponds to said optimized total profit.

18. The method of optimizing a plurality of ground engaging operations of claim 16, including the step of ascertaining optimized operating parameters associated with each of said plurality of ground engaging operations, said optimized operating parameters including at least one of a sequence of said plurality of ground engaging operations, a timing of said plurality of ground engaging operations, and at least one execution parameter for a respective work machine associated with each said ground engaging operation.

19. The method of optimizing a plurality of ground engaging operations of claim 18 wherein said timing of said plurality of ground engaging operations includes said start time and said execution time for each of said plurality of ground engaging operations.

20. The method of optimizing a plurality of ground engaging operations of claim 18, wherein said at least one execution parameter includes an operating speed of said respective work vehicle.

21. The method of optimizing a plurality of ground engaging operations of claim 16, wherein said ground engaging operation comprises an agricultural operation, and said value comprises a crop value.

22. The method of optimizing a plurality of ground engaging operations of claim 21, wherein said crop value is based upon an expected yield and a target selling price.

23. The method of optimizing a plurality of ground engaging operations of claim 22, wherein said expected yield is based upon at least one of historical field data, historical county average data, and position based remote field sensing.

24. The method of optimizing a plurality of ground engaging operations of claim 16, wherein said ground engaging operations comprise agricultural operations, and said manageable costs include at least one of equipment costs, labor costs, and crop loss and damage costs.

25. The method of optimizing a plurality of ground engaging operations of claim 24, wherein said crop loss and damage costs include at least one of:
crop loss and damage caused by equipment;
crop loss and damage caused by weather;
crop loss and damage caused by timing of said ground engaging operation; and
crop loss and damage caused by latent conditions.

26. The method of optimizing a plurality of ground engaging operations of claim 25, wherein said latent conditions include at least one of soil compaction, poorly distributed trash on field, and promotion of disease and pests resulting from said ground engaging operation.

27. The method of optimizing a plurality of ground engaging operations of claim 16, wherein said ground engaging operation comprises one of an agricultural operation, timber operation and construction operation.

28. A system for optimizing a plurality of ground engaging operations in a plurality of geographic units, each said ground engaging operation carried out using a respective work machine, said system comprising:
a non-volatile memory including data corresponding to a value of each said ground engaging operation at an assumed start time, and at least one manageable cost associated with each said ground engaging operation;
an electrical processing circuit coupled with said memory, said electrical processing circuit configured for determining an optimized total profit associated with all of ground engaging operations using a summation of net profits respectively associated with each said ground engaging operation, each said net profit being dependent upon an assumed start time and execution time associated with said ground engaging operation, said value associated with said ground engaging operation, and a number of manageable costs associated with said ground engaging operation; and
an operator output device providing a schedule to an operator corresponding to said optimized total profit.

29. The system for optimizing a plurality of ground engaging operations of claim 28, wherein said operator output device includes at least one of a visual output and an audio output.

30. The system for optimizing a plurality of ground engaging operations of claim 29, wherein said visual output includes at least one of a video display and an email notification, and said audio output includes at least one of a page, phone call, beep and alarm.

31. The system for optimizing a plurality of ground engaging operations of claim 28, wherein said electrical processing circuit is coupled with said memory via one of wired and wireless communication.

32. The system for optimizing a plurality of ground engaging operations of claim 28, wherein said operator output device is coupled with said electrical processing circuit via one of wired and wireless communication.

33. The system for optimizing a plurality of ground engaging operations of claim 28, including a geopositioning sensor coupled with said electrical processing circuit.

34. The system for optimizing a plurality of ground engaging operations of claim 28, wherein said electrical processing circuit includes a microprocessor.
